(19) United States
(12) Patent Application Publication
(10) Pub. No.: US 2004/0078243 A1
(43) Pub. Date: Apr. 22, 2004

(54) Automatic insurance processing method

(76) Inventor: Fredrick J. Fisher, Los Angeles, CA (US)

Correspondence Address: STITES & HARBISON PLLC, 1199 NORTH FAIRFAX STREET, SUITE 900, ALEXANDRIA, VA, 22314, US

(21) Appl. No.: 10/226,284

(22) Filed: Aug. 23, 2002

Related U.S. Application Data
(60) Provisional application No. 60/384,824, filed on Jun. 4, 2002.

(51) Int. Cl. G06F 17/60

(52) U.S. Cl. 705/4

(57) ABSTRACT

A method is provided for facilitating insurance transactions between prospective insureds and potential insurance underwriters. A distributed communications network is used to effect registering, by a user of the network, through a wholesale intermediary, of a prospective insured. If the prospective insured qualifies, the user is provided with a preliminary application for insurance of a given type. The application as completed by the user is transmitted to wholesale intermediary by e-mail. The wholesale intermediary then forwards the application to underwriters that have been pre-approved by the wholesale intermediary. An underwriting evaluation from each of the underwriters is received, through e-mail, by both the user and the wholesale intermediary so that the latter can assist the user. Each evaluation is maintained in confidence and is not known by the other underwriters.

### CROSS-REFERENCE TO RELATED APPLICATIONS

This application claims benefit of the filing date of copending Provisional Patent Application No. 60/384,824, filed on Jun. 4, 2002.

### FIELD OF THE INVENTION

The present invention relates to the processing of applications for insurance coverage and more particularly, to an improved method for facilitating the purchase of insurance which uses a distributed communications network such as the Internet.

### BACKGROUND OF THE INVENTION

As indicated above and as discussed in more detail below, the present invention concerns an automated insurance processing which uses the Internet or a like distributed communication network. It will be appreciated that the use of distributed communications networks such as the Internet in connection with commercial insurance applications is not new. Sites providing these services basically fall into three categories. In a first category, online applications are billed out or printed out by the host or hub and submitted to an insurance company by telefax or e-mail. Substantial manual handling on the part of the host is required. A further category is insurance portals, i.e., fee based insurance systems operating as a business-to-business (B2B) site wherein brokers pay a fee to post messages and/or provide application pick-up by an insurance company representative who must also pay a fee to use the system. Both parties must have user names or passwords to log into the system. An example is http://www.insuretrade.com. A third category is online systems that automatically prepare, and do the calculations for, an online application for an immediate indication and/or quote. It may or may not be possible to bind coverage online. An example is http://www.insuretrade.com.

Patented prior art of interest includes U.S. Patent Application Publication No. 2001/0049611 A1 to Peach, which discloses a method for electronically acquiring insurance policy data from prospective clients using standard application forms and distributing this data to agent offices. In accordance with this method, the client contacts an agent and provides the information necessary to obtain a quote or indication on a policy. This information is transmitted by an agent over the Internet to insurance carrier databases on a central system or server. The insurance policy information is automatically entered into a standard insurance industry form. Based on the data in the form, an insurer may accept the application and issue a policy, while also conveying this to requesting agent, or return completed forms to the agent. Completed forms may be compressed into a single file for transmission to the insurance agent as e-mail or may be made available for direct downloading from the server by the agent. The agent may present the completed policy to the client or pass on the forms to other agents/insurance companies.

U.S. Patent Application Publication No. 2002/0002494 A1 to Beam et al. discloses a system and method for facilitating appraisals for real property over a network such as the Internet. In this method, upon receipt of a request for an appraisal, a database is consulted to find and select an appraiser and appraisal information is sent to the selected appraiser. After completion of the appraisal, the appraiser uploads the appraisal information and the hub or host transfers this information to the requester or other customer. The information requests and responses may be sent by e-mail and can be stored at a central location, i.e., at the hub.

WO 01/01229 A1 to Prasad et al. discloses a method for providing financial services, such as insurance services, wherein a customer is asked by the host to submit personal and financial information. This information is converted into financial indicator data, entered into the appropriate database and then sent to a plurality of insurance providers for completing bids. The bids are collected for evaluation and the best bid is forwarded to the customer by, e.g., e-mail. The method is executed on a distributed communications network such as the Internet.

Other patents and applications of potential interest include U.S. Patent Application Publication Nos. 2001/0032091 A1 to Schultz, 2001/0034622 A1 to Davis, 2001/20037205 A1 to Joao, 2002/0002469 A1 to Hillstrom, and 2002/0003490 A1 to Cutaia et al.; U.S. Pat. No. 5,864,827 to Wilson, U.S. Pat. No. 5,995,939 to Berman et al., U.S. Pat. No. 6,021,397 to Jones et al., U.S. Pat. No. 6,067,531 to Hoyt et al., U.S. Pat. No. 6,321,202 B1 to Raveis, Jr., U.S. Pat. No. 6,330,551 B1 to Burchetta et al., U.S. Pat. No. 6,338,050 B1 to Conklin et al., and WO 00/66853 (WIPO 11/2000) and EP 1 067 422 A3 (January 2001).

### SUMMARY OF THE INVENTION

In accordance with the invention, a method provided which affords a number of improvements to or advantages over methods currently in use. The method provides a single “short application” or “online application” that can be submitted to multiple insurers. This saves brokers and customers time and effort. Further, in contrast to many systems, the method uses electronic means to submit the application. By taking advantage of the increasingly widespread use (and decreasing cost) of e-mail and web access, both costs and time are reduced as compared to conventional prior art approaches. Examples of these conventional approaches include paper applications completed in person, and those transmitted by facsimile, courier, postal mail, and express mail, all of which are slower and more expensive than the electronic means used in the system of the invention. In addition, the system improves market penetration for the insurers and provides increased value to the end user. In the latter regard, by making it possible to present applications to a number of markets with no extra effort on the part of the applicant or submitter, the submitter sees value from competition. In this regard, quotes vary widely, and, in actual practice, it has been found that quotes from different underwriters may differ from each other by a multiplying factor of two and even three. In addition, insurers who have coverage available for smaller and often overlooked markets have the opportunity to be represented in a wider area without substantial marketing cost, simply by signing up to receive requests for indications. Other examples of improvements or advantages provided by the invention are discussed below.

According to one aspect of the invention, a method is provided for streamlining two steps in the process for purchasing professional liability, employment practice, director and officer, and other specialty lines insurance (referred herein as “PL” insurance), although it will be understood that the invention is not limited to PL insurance. By way of background, there are four basic time consuming and labor intensive steps involved in the typical PL insurance purchase, as follows:

receiving from a potential client (prospective insured) an initial inquiry, application or request for a premium quote;

returning non-binding quotes or indications to the potential client;

negotiating the various alternatives and costs between the potential client and the underwriters; and

finalizing and binding the insurance.

As indicated above, the invention streamlines the first two steps in the process and is intended to increase the number of new policies written by a wholesale insurance broker or wholesale intermediary using the system. Most of these new policies will come through retail insurance brokers, but some will come directly from retail insurance purchasers, if they reside in states in which the wholesale broker is licensed. Generally, the wholesale broker will refer a retail purchaser to a retail broker in the purchaser's area.

The invention provides for the use of a web-based portal that allows selected retail brokers to register and indicate what type of professional liability and specialty lines insurance they are willing to underwrite, and to indicate their own parameters for accepting inquiries. The portal will also allow a potential buyer, whether a retail broker or a direct retail purchaser, to access the site and to complete a preliminary application form providing typical information about the buyer and indicating the type and amount of insurance desired. The application is preferably filled out online and is designed by the wholesale intermediary so as to provide prescribed information of a character and in a format that will enable an underwriter to determine whether there is sufficient interest to provide a quote. In other words and more generally, the invention allows a retail broker or retail purchaser to fill out an initial or preliminary application, providing the typical information that would be required by an underwriter, including the type and amount of insurance desired.

Upon the submission of an inquiry by a potential buyer and after an approved application is received, the site automatically forwards the inquiry to, and only to, those underwriters who, in the process of being registered with the site, have indicated an interest in receiving inquiries similar to the one just submitted. The roster of underwriters is preferably compiled by the host, e.g., the wholesale intermediary, by contacting specific insurance company underwriters with whom there is an existing business nexus. Thus, in accordance with a preferred embodiment, underwriters cannot automatically register to use the system. More generally, in accordance with this aspect of the invention, the wholesale broker maintains a database of underwriters including their specialties and limitations and, once an initial application is received and approved, a copy of the approved application is forwarded electronically, e.g., e-mailed, to those underwriters deemed by the wholesale broker to be the most appropriate.

Each underwriter that receives a copy of the inquiry, i.e., the approved application, and evaluates it manually in accordance with its own rules and procedures. Then, if the underwriter chooses, a non-binding indication is forwarded electronically to the person who submitted the inquiry. In accordance with a preferred embodiment, the website automatically and simultaneously forwards a copy of the underwriter's response to the wholesale broker at the same time that the response is sent to the potential client or to a submitting broker submitting on behalf of the ultimate consumer. Thus, by simultaneously receiving the non-binding indications, as well as any denials, the wholesale broker is in a position to follow up with the potential buyer and/or the underwriter in a timely manner either to arrange to bind coverage or to take such action as may be warranted under the circumstances, including directing the potential buyer to other underwriters, as appropriate. In other words, and more generally, each underwriter evaluates the preliminary application in accordance with its own rules and methods and, if appropriate, transmits a non-binding indication simultaneously to the wholesale broker and the potential client. By simultaneously receiving the non-binding indications, as well as any denials, the wholesale broker can monitor the responses and contact the retail broker, or the potential retail client, in a timely manner, should the wholesale broker have better alternatives to offer.

In accordance with one aspect of the invention, there is provided a method for facilitating insurance transactions between prospective insureds and potential insurance underwriters, said method comprising:

using a distributed communications network to effect registering, by a user of the network, through a wholesale intermediary, of a prospective insured and, if the prospective insured qualifies, to provide the user with a preliminary application for insurance of a given type;

receiving the application as completed by the user and transmitted to wholesale intermediary by e-mail and, as necessary, requiring further interations of the application by the user until an approved application is received;

forwarding by the wholesale intermediary of the approved application, with corresponding identifying data, to a plurality of underwriters that have been pre-approved by the wholesale intermediary for selling insurance of the given type so that the underwriters can provide an underwriting evaluation;

receiving by the user, and the wholesale intermediary, through e-mail, an underwriting evaluation from each of the underwriters if the underwriting evaluation is other than a refusal while maintaining the evaluations in confidence so that the evaluation of each of the underwriters is not known by the other underwriters; and

storing by the wholesale intermediary of all of the underwriting evaluations received thereby from the underwriters for said approved application so that the wholesale intermediary can assist the user on completing a transaction between the prospective insured and one of the underwriters providing an underwriting evaluation.

Preferably, the preliminary application is created by the wholesale intermediary and is specifically tailored to insurance of the given type. Advantageously, the preliminary application requires acceptance by the user of a disclaimer authored by the wholesale intermediary before the application is approved.

In a preferred implementation, the underwriters must log in to submit an evaluation and the method is terminated for a particular underwriter when no evaluation is received.

Advantageously, the choice of the underwriters to which the approved application is forwarded is completely controlled by the wholesale intermediary.

Preferably, a positive underwriting evaluation is one of (i) a non-binding indication and (ii) a request for more information adapted to lead to a non-binding indication.

In accordance with a further aspect of the invention, there is provided a method for enabling facilitation by a wholesale intermediary of an insurance transaction between a prospective insured and one of a plurality of insurance underwriters potentially interested in underwriting an insurance policy for the prospective insured, said method comprising:

registering, using a distributed communications network, a plurality of insurance underwriters;

registering, using a distributed communications network, a submitter of a request for an application if the submitter qualifies for registration;

after registering the submitter, electronically forwarding a preliminary application to the submitter, requesting insurance information of a character and in a format predetermined by the wholesale intermediary;

electronically receiving the application, as filled out by the submitter, back from the submitter and, as necessary, effecting changes in the application until an approved application is generated;

selecting underwriters from the plurality of registered underwriters for receiving the approved application and electronically forwarding the approved application to the selected underwriters for evaluation thereby; and

receiving electronically from those of the selected underwriters choosing to respond, a response based on evaluation of the underwriter, which is also contemporaneously transmitted electronically to the submitter, so that the wholesale intermediary can assist the submitter selecting one of the responding underwriters and in completing, as desired, a transaction with a selected one of the corresponding underwriters.

In one advantageous implementation, when the response by the selected underwriter is not wholly negative, the response is followed, depending on the reply from the submitter, by a non-binding indication with respect to an insurance policy.

Preferably, as above, a positive response by the underwriter is one of (i) a non-binding indication with respect to an insurance policy based on the approved application and (ii) a request for additional information. Advantageously, the preliminary application is created by the wholesale intermediary and is specifically tailored to insurance of a given type. As above, the choice underwriters to which the approved application is forwarded, is, preferably, completely controlled by the wholesale intermediary.

Also, as above, preferably, the underwriters must log in to submit an evaluation and wherein the method is terminated for a particular underwriter when no evaluation is received.

In accordance with yet another aspect of the invention, there is provided a method of facilitating insurance transactions between a potential insurance underwriter interested in underwriting a given type of insurance and prospective insured seeking the given type of insurance, said method comprising:

using a distributed communications network to register with a wholesale intermediary as one underwriter of a plurality of registered underwriters interested in underwriting the given type of insurance;

receiving electronically applications containing insurance information of a character and in a format approved by the wholesale intermediary and submitted by a submitter as a prospective insured or on behalf of a prospective insured;

evaluating the submitted application and based on the evaluation, transmitting a response electronically to both the submitter and to the wholesale intermediary so that, if the response is positive, the wholesale intermediary can assist the submitter completing a binding transaction between the prospective insured and said one insurance underwriter.

Preferably, the one underwriter provides a positive response when an evaluation of yes or maybe is made as to whether an indication will be provided and logs into a website of the wholesale intermediary to provide said positive response.

Preferably, when, based on said evaluation, said one underwriter is not interested in providing an indication, said one underwriter can either fail to reply or log into said website to indicate a negative reply, and the method is terminated for said one underwriter.

Advantageously, said one underwriter is screened by said wholesale intermediary as part of registering with said wholesale intermediary and acceptance of said one underwriter as of said registered underwriters is at the discretion of said wholesale intermediary.

In one advantageous implementation, depending on the evaluation, the response transmitted to both the submitter and the wholesale intermediary is a nonbinding indication in electronic form. Beneficially, the response is transmitted substantially simultaneously to both the submitter and the wholesale intermediary.

Further features and advantages of the present invention will be set forth in, or apparent from, the detailed description of preferred embodiments thereof which follows.

### BRIEF DESCRIPTION OF THE DRAWINGS

FIG. 1 is a block diagram or flow chart of some of the basic steps, on the retail side, of the method of the invention, in accordance with a preferred embodiment; and

FIG. 2 is a block diagram or flow chart of some of the basic steps, on the underwriter's side, of the method of the invention, in accordance with a preferred embodiment.

### DESCRIPTION OF THE PREFERRED EMBODIMENTS

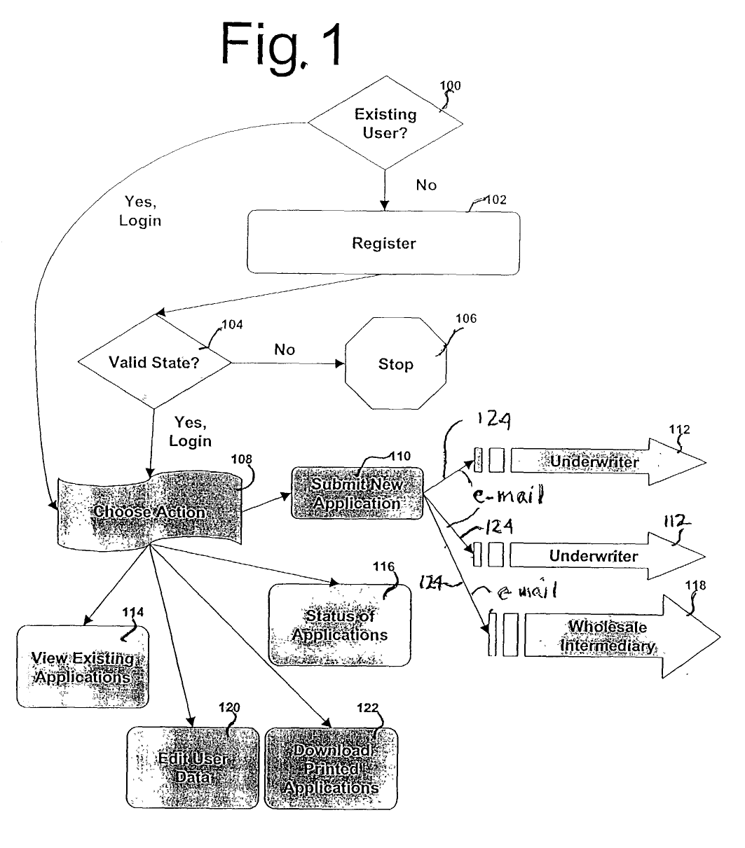

Referring to FIG. 1, there is shown a flow chart or block diagram of the procedure or method of the invention, at the retail level. As indicated by block 100, a user navigates to the web site and is presented with the choice of registering or logging into the system. An unregistered user must register to use the system. Registration, represented by block 102, consists of providing identifying information regarding the user, a desired username and password to access the system in the future, and a valid e-mail address. Registration also constitutes acceptance of the fair use policy, which is available from a link on the registration page. During registration, the location of the user is recorded and compared against a list of states for which the system is valid, as indicated by block 104. Due to restrictions and licensing variables for mga's, insurers, and brokers, not all states are necessarily available for each product, and some consumers in non-listed states have no eligibility because there is no broker participating in the system to write policies in those states. If the user/consumer, as opposed to a licensed broker, is not in a “valid” state for any of these reasons, access to the system is denied (block 106) and the consumer must then have a local broker in that state register on the consumer's behalf.

If, during registration (block 102) or at initial entry to the system (block 100), the user is determined to be from a valid state and successfully logs into the system, the user is presented with several options, as represented by block 108. These options include the following:

Submit New Application (block 110): Here, the user is presented with a menu of available choices, listing the lines of business which are currently eligible based on the state that the risk is in, and the insurers currently available in the system. This application is discussed in further detail below.

View Existing Applications (block 114): With this option the user has the ability to view applications which have been previously submitted. This ability to view applications is limited but, for example, in the case of a user who is a broker, all applications submitted by that broker are visible here, since brokers submit applications on behalf of proposed or prospective insureds.

Status of Applications (block 116): The list of applications in the system includes the number of indications that have been entered for each application. By clicking on the reference number of a particular submission, or otherwise accessing the system, a display is provided of a list of the indications available, along with the name of the underwriter who provided the indication and the amount of the indication.

Edit User Data (block 120): This option allows the user to edit demographic and contact information.

Download Printed Applications (block 122): This option provides access to electronic copies of official printed applications from various insurers, in a particular format (e.g., the Adobe Acrobat® format). It is noted that many insurers require an application be provided on their own, official application forms prior to binding an insurance policy.

Considering the application submission step (block 110) in more detail, as indicated above, the applications are preferably online forms which request information from the user regarding the proposed insured. Various lines of business are represented, and each has a different online application tailored to the specific needs of insurers. Accordingly, some applications are relatively short, while others are longer and require more detail. This detail can include information such as the percentage of the proposed insured's revenue derived from very specific business activities in a given time period (e.g., in the last year, or the last three years). Preferably, the applications are designed by the wholesale intermediary, after consulting with the insurers or based on the knowledge, gained through experience, of the wholesale intermediary as to the typical needs of the insurers.

Most fields of the application are required to be filled in. In this regard, if a field is not applicable, then the field is to be marked “N/A” to so indicate. When a submit button is clicked or another indication provided that the application has been completed, the application is checked by administrative personnel of the wholesale intermediary for completeness and proper input. If any fields that are required to be filled in contain no information, the form is presented to the user again with the required field(s) indicated. The user must properly complete the form, including accepting the disclaimer at the bottom of the application, before the application will be accepted.

Once an application is accepted, email messages, as indicated by lines 124, are sent to the user, to the underwriters (indicated by blocks 112) who have been designated to receive applications for the desired line of business, and to the wholesale intermediary, block 118. The email message contains the entire application as completed by the user, and may be viewed online or printed for review. Typically, a particular administrator of the wholesale intermediary is assigned as part of the administrative procedure described below and is responsible for following the progress of the application and for attempting to write a policy for the proposed insured with one of the insurers.

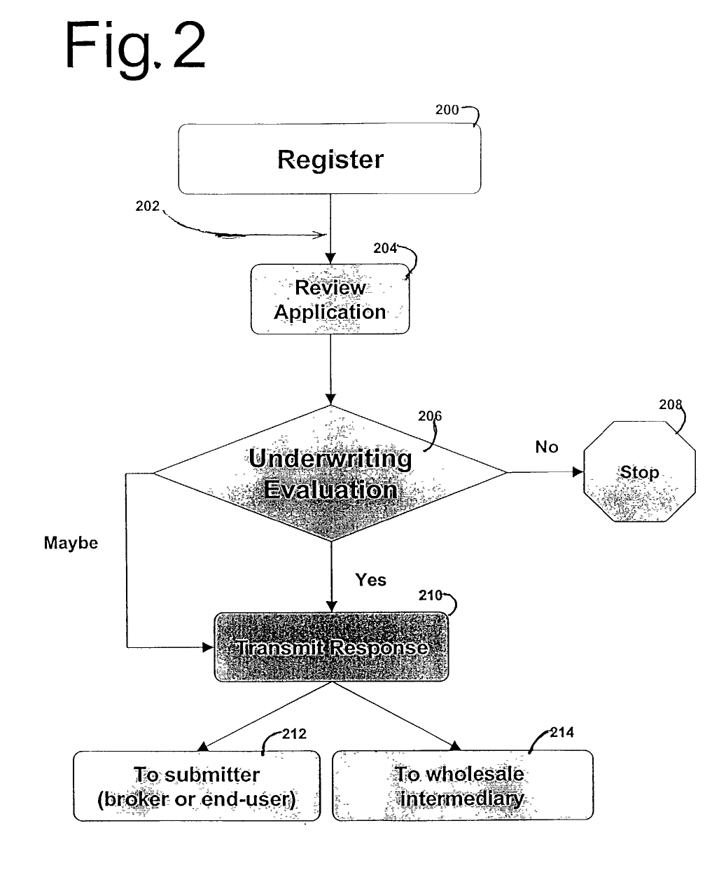

Referring to FIG. 2, there is shown a block diagram or flow chart of the method or procedure of the invention, at the underwriter level. Unlike users, underwriters cannot register for access to the system and log into the system in order to view existing applications. Instead, the host or wholesale intermediary must pre-screen the underwriters and must specifically register them (block 200) and assign them their username and password. Upon registration, an email message, indicated by line 202, is sent with confirming information to the underwriter, together with information as to what applications the underwriter will receive with respect to the various products available. In general, all of the insurance products are not suitable for every underwriter and the decision as to which of the products offered will be received by a particular underwriter is made by the host. Thus, only those products assigned to the underwriter will be received by that underwriter.

An underwriter is notified of a pending application by receipt of an email message containing the application in HTML format, this e-mail message corresponding to that indicated at 124 in FIG. 1, and as represented by blocks 112. The underwriter may review the application online (block 204) and when this review is completed, the underwriter makes an underwriting evaluation. In general, the evaluation is yes, no, or maybe as indicated below. The underwriter must log into the system to enter the underwriting decision.

A decision of no (i.e., to decline to offer an indication) does not require any action, but it may be entered by the underwriter (block 208). No further action is taken by the system.

A decision of yes (i.e., a positive evaluation in which an indication is included) or maybe (which usually involves a request for more information) is positively entered by the underwriter, and then becomes available to the proposed insured or broker (as indicated at 116 in FIG. 1). In addition, an email message is generated, as indicated by block 210, with copies to the originator or submitter (who may be a broker or a consumer), as indicated by block 212, and the wholesale intermediary, as indicated by block 214. The company underwriters then do whatever is needed to work up a “ballpark,” non-bindable indication. They then return to the website, and using the assigned submission number, input their indication by providing limits, deductibles, proposed price or price range, type of policy form, and a text box so that endorsements and/or other requirements can be listed, so that the submitter, i.e., the proposed insured, can obtain a firm quote.

To obtain a firm quote, the submitter has to transmit what is required to the wholesale intermediary in the “traditional” way, i.e., in the way that things are conventionally done in the industry. However, as indicated above, the terms provided by the underwriters will be transmitted by e-mail to the submitter with a copy to the wholesale intermediary.

It will be appreciated that the relations here are “many to one” in that there could be many underwriters quoting on the same account. A particular underwriter is not able to know about the others nor to see what others have quoted for a particular account. At all times, the wholesale intermediary receives copies of all e-mail notifications so that they can be tracked for follow-up. The form to e-mail component is sent to the underwriters (based on an underwriting eligibility matrix) so as to allow the underwriter to view the submission without accessing the site. Within the e-mail component is a link to the site so that the underwriter can log in and post information such as that mentioned above (price range, limits, deductibles, policy forms, endorsement information, etc). The form to e-mail component that is sent to the submitter, i.e., the originator of the submission (whether direct consumer or agent/broker), when the indication is submitted by the underwriter also includes informational elements necessary to successfully complete the transaction.

It will, of course, be appreciated from the foregoing that the system requires administration. Some of the functions of the system which must be administered include the following:

User approval. A user who registers to access the system (see block 120 of FIG. 1) must be approved by the administrator;

Underwriter entry. Underwriters are also approved by the administrator and set up is also exclusively done by the administrator; and

Underwriter assignment. Each underwriter is assigned to a specific employee of the wholesale intermediary who is responsible for oversight of all applications directed to that underwriter. Of course, a particular employee may be assigned to oversee multiple underwriters. For all types of users described above, the administrator may grant or deny access, assign passwords, and view or edit information about the user.

The web server is used for many functions or tasks, including the following: registration and application submission; receiving of copies of all completed applications; receiving of e-mail traffic between participants; tracking of applications by users/brokers; tracking of indications by underwriters; and storage of all indications received for each application.

As should be evident from the discussion above, the method and system of the invention, in general, provide the following:

(i) collecting insurance applicant information; (ii) directing applicant information to the proper individuals and/or organizations for review; (iii) entering and storing “indications” of insurance, an indication being, as indicated previously, an estimate of the premium to be offered if the full application meets underwriter guidelines and is approved by underwriter; (iv) notification of the applications received and the indications entered; and (v) administration and oversight of all users, brokers, underwriters, employees, etc.

As should be apparent, the method and system of the invention differ from other methods and systems now currently available the following ways, among others: (i) the system does not attempt to assign risks or provide quotes automatically; rather, it provides a means for prospective insureds and for their representatives to obtain indications from various potential insurers; (ii) the system does not provide an auction environment; the potential insurers are not aware of how many competitors there are, who they are, what rates that they may propose, or even if others have been invited to submit indications; furthermore, there is no commitment by either party, whether written or implied, growing out of the use of the system, and, in a preferred implementation, no fee is charged for use of the system; (iii) in contrast to some other prior art systems, the system is not a messaging or bulletin board system; there is no provision for a “free flow” of information among users and, essentially, each request is a discrete transaction; further, while there may be several responses, the number of insurers to which the request is presented is dependent on the line of business the risk is in, the markets an insurer has expressed interest in covering, and the initial underwriter's evaluation of the online application. In this latter regard, a particular underwriter may simply choose not to provide an indication for a particular risk.

Although the invention has been described above in relation to preferred embodiments thereof, it will be understood by those skilled in the art that variations and modifications can be effected in these preferred embodiments without departing from the scope and spirit of the invention.

What is claimed is:

1. A method for facilitating insurance transactions between prospective insureds and potential insurance underwriters, said method comprising:
using a distributed communications network to effect registering, by a user of the network, through a wholesale intermediary, of a prospective insured and, if the prospective insured qualifies, to provide the user with a preliminary application for insurance of a given type;
receiving the application as completed by the user and transmitted to wholesale intermediary by e-mail and, as necessary, requiring further interations of the application by the user until an approved application is received;
forwarding by the wholesale intermediary of the approved application, with corresponding identifying data, to a plurality of underwriters that have been pre-approved by the wholesale intermediary for selling insurance of the given type so that the underwriters can provide an underwriting evaluation;
receiving by the user, and the wholesale intermediary, through e-mail, an underwriting evaluation from each of the underwriters if the underwriting evaluation is other than a refusal while maintaining the evaluations in confidence so that the evaluation of each of the underwriters is not known by the other underwriters; and
storing by the wholesale intermediary of all of the underwriting evaluations received thereby from the underwriters for said approved application so that the wholesale intermediary can assist the user on completing a transaction between the prospective insured and one of the underwriters providing an underwriting evaluation.

2. A method according to claim 1 wherein the preliminary application is created by the wholesale intermediary and is specifically tailored to insurance of the given type.

3. A method according to claim 2 wherein the preliminary application requires acceptance by the user of a disclaimer authored by the wholesale intermediary before the application is approved.

4. A method according to claim 1 wherein the underwriters must log in to submit an evaluation and wherein the method is terminated for a particular underwriter when no evaluation is received.

5. A method according to claim 1 wherein the choice of the underwriters to which the approved application is forwarded is completely controlled by the wholesale intermediary.

6. A method according to claim 1 where the underwriting evaluation is one of (i) a non-binding indication and (ii) a request for more information adapted to lead to a non-binding indication.

7. A method for enabling facilitation by a wholesale intermediary of an insurance transaction between a prospective insured and one of a plurality of insurance underwriters potentially interested in underwriting an insurance policy for the prospective insured, said method comprising:
registering, using a distributed communications network, a plurality of insurance underwriters;
registering, using a distributed communications network, a submitter of a request for an application if the submitter qualifies for registration;
after registering the submitter, electronically forwarding a preliminary application to the submitter, requesting insurance information of a character and in a format predetermined by the wholesale intermediary;
electronically receiving the application, as filled out by the submitter, back from the submitter and, as necessary, effecting changes in the application until an approved application is generated;
selecting underwriters from the plurality of registered underwriters for receiving the approved application and electronically forwarding the approved application to the selected underwriters for evaluation thereby; and
receiving electronically from those of the selected underwriters choosing to respond, a response based on evaluation of the underwriter, which is also contemporaneously transmitted electronically to the submitter, so that the wholesale intermediary can assist the submitter selecting one of the responding underwriters and in completing, as desired, a transaction with a selected one of the corresponding underwriters.

8. A method as claimed in claim 7 wherein, when the response by the selected underwriter is not wholly negative, the response is followed, depending on the reply from the submitter, by a non-binding indication with respect to an insurance policy.

9. A method as claimed in claim 7 wherein the response by the underwriter is one of (i) a non-binding indication with respect to an insurance policy based on the approved application and (ii) a request for additional information.

10. A method as claimed in claim 7 wherein the preliminary application is created by the wholesale intermediary and is specifically tailored to insurance of a given type.

11. A method as claimed in claim 7 wherein the underwriters must log in to submit an evaluation and wherein the method is terminated for a particular underwriter when no evaluation is received.

12. A method as claimed in claim 7 wherein the choice of the underwriters to which the approved application is forwarded is completely controlled by the wholesale intermediary.

13. A method of facilitating insurance transactions between a potential insurance underwriter interested in underwriting a given type of insurance and prospective insured seeking the given type of insurance, said method comprising:
using a distributed communications network to register with a wholesale intermediary as one underwriter of a plurality of registered underwriters interested in underwriting the given type of insurance;
receiving electronically applications containing insurance information of a character and in a format approved by the wholesale intermediary and submitted by a submitter as a prospective insured or on behalf of a prospective insured;
evaluating the submitted application and based on the evaluation, transmitting a response electronically to both the submitter and to the wholesale intermediary so that, if the response is positive, the wholesale intermediary can assist the submitter completing a binding transaction between the prospective insured and said one insurance underwriter.

14. A method according to claim 13 wherein said one underwriter provides a positive response when an evaluation of yes or maybe is made as to whether an indication will be provided and logs into a website of the wholesale intermediary to provide said positive response.

15. A method according to claim 14 wherein, when based on said evaluation, said one underwriter is not interested in providing an indication, said one underwriter can either fail to reply or log into said website to indicate a negative reply, and the method is terminated for said one underwriter.

16. A method according to claim 14 wherein said one underwriter is screened by said wholesale intermediary as part of registering with said wholesale intermediary and acceptance of said one underwriter as of said registered underwriters is at the discretion of said wholesale intermediary.

17. A method according to claim 13 wherein said response transmitted to both the submitter and the wholesale intermediary is a non-binding indication in electronic form.

18. A method according to claim 17 wherein said response is transmitted substantially simultaneously to both the submitter and the wholesale intermediary.
